(19) United States
(12) Patent Application Publication
(10) Pub. No.: US 2013/0205941 A1
(43) Pub. Date: Aug. 15, 2013

(54) HORIZONTAL ATTITUDE STABILIZATION DEVICE FOR DISC AIR VEHICLE

(71) Applicant: Yuji Tanose, Tottori-shi (JP)

(72) Inventor: Yuji Tanose, Tottori-shi (JP)

(21) Appl. No.: 13/574,695

(22) PCT Filed: Aug. 11, 2011
(86) PCT No.: PCT/JP11/68644

§ 371 Date: Jul. 23, 2012

(30) Foreign Application Priority Data
Oct. 18, 2010 (JP) 2010-247882

(51) Int. Cl. B64C 17/06

(52) U.S. Cl. CPC B64C 17/06
USPC 74/572.2

(57) ABSTRACT

Three flywheels which have the same size and the same weight at equal distances/equal intervals from the gravity of a disc air vehicle are tandem-arranged on the horizontal surface passing through a gravity point which is the center of the disc air vehicle, and the flywheels are fast rotated by power such as a motor or an engine in the same direction and at the same speed, whereby the three flywheels generate combined centrifugal force with an unreal vertical axis passing through the gravity thereof as the center.

### CROSS REFERENCE TO RELATED APPLICATION

This application is the 35 U.S.C. §371 national stage of PCT application PCT/JP2011/068644, filed Aug. 8, 2011, the disclosure of which is hereby incorporated by reference.

### TECHNICAL FIELD

The present invention relates to a device for controlling a vertical takeoff and landing air vehicle, such as a small disc hovering aircraft for low altitude flight, to easily stabilize a horizontal attitude thereof.

### BACKGROUND ART

In many cases, a vertical takeoff and landing aircraft has an airframe that includes a plurality of jet engines or fans for flotation. There has been adopted a method of detecting inclination with use of a gyro sensor and controlling or inclining thrust of each of the jet engines or the fans so as to stabilize horizontally, or a method of regulating individual thrust or inclination by operations of a person so as to stabilize horizontally.

The methods according to the related art have the following problems.
A. It is difficult to horizontally stabilize the airframe because there is generated a time lag from detection of inclination of the airframe with a sensor to execution of control operations.
B. In order to horizontally stabilize by operations of a person, such operations need to be performed by an experienced pilot, which is not a usual case. The present invention has been achieved in order to solve these defects.

### BRIEF DESCRIPTION OF THE DRAWINGS

FIG. 1 is a perspective view of a small disc hovering aircraft for low altitude flight, on which a horizontal attitude stabilization device according to the present invention is mounted.

FIG. 2 is a transverse sectional view of the small disc hovering aircraft for low altitude flight, on which the horizontal attitude stabilization device according to the present invention is mounted.

FIG. 3 is a downward view of the small disc hovering aircraft for low altitude flight in the present invention, in a state where an upper body of a trunk thereof is removed.

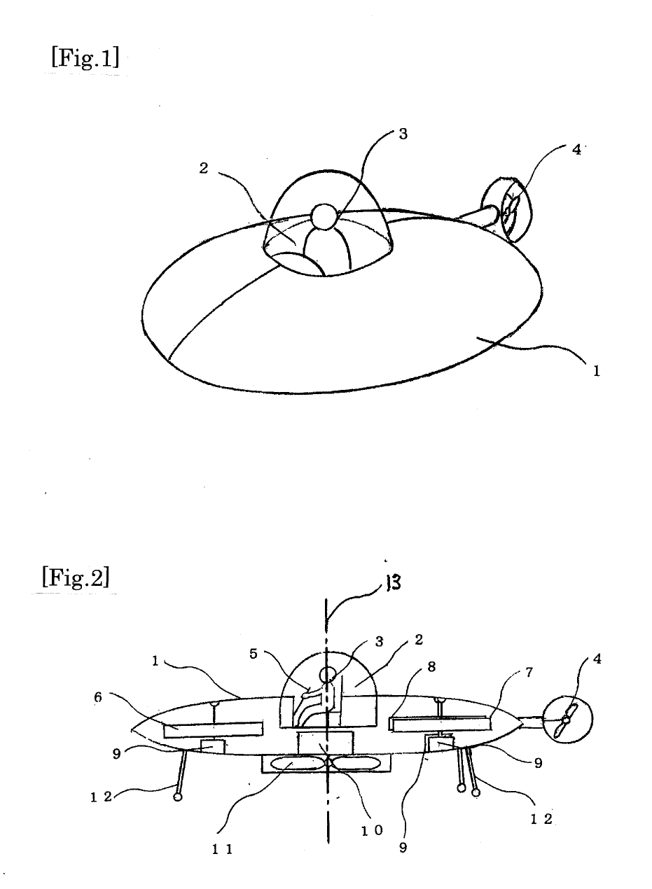

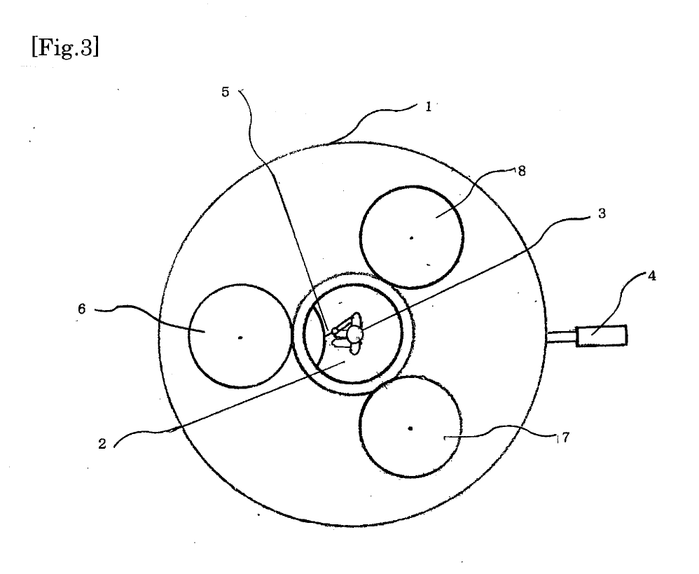

### DESCRIPTION OF REFERENCE SIGNS

1 Trunk of disc air vehicle
2 Cockpit
3 Pilot
4 Tail rotor
5 Control stick
6 First flywheel
7 Second flywheel
8 Third flywheel
9 Power for flywheel
10 Power for flotation and propulsion
11 Fan for flotation and propulsion
12 Leg
13 Vertical axis passing through gravity of airframe

### DETAILED DESCRIPTION

The present invention provides a configuration in which three flywheels each having a same size and a same weight are tandem-arranged on a horizontal surface passing through a gravity point as a center of a disc air vehicle at equal distances/equal intervals from the gravity thereof. When the flywheels are rotated fast by power of a motor or an engine in a same direction and at a same speed, the three flywheels generate combined centrifugal force about a vertical axis passing through the gravity of the air vehicle. As a result, the attitude of a main body of the disc air vehicle is constantly stabilized horizontally, in accordance with the law that a rotating top does not fall down. These three flywheels can be continuously rotated by power, because the respective axes thereof are located apart by an equal distance from the vertical axis passing through the gravity of the disc air vehicle. Therefore, each of the flywheels serves as a permanent top and does not fall down unlike an ordinary top, of which rotational power is reduced naturally.

### EFFECTS OF THE INVENTION

The present invention exerts the following effects.
A. The airframe is constantly stabilized horizontally by combined centrifugal force that is generated by the three flywheels being rotated by power. Accordingly, there is no need to control or operate thrust of each of the plurality of jet engines or the plurality of fans for flotation and horizontal stabilization, in order to stabilize horizontally.
B. The airframe is constantly stabilized horizontally due to rotation of the three flywheels. Thus, it is necessary to arrange only one jet engine or only one fan for flotation and propulsion at the center of the airframe. Consequently, it is possible to enable flight with use of two parts, namely, a jet engine or a fan for flotation and a tail rotor for preventing rotation of the airframe in synchronization with rotation of the flywheels.

### BEST MODE FOR CARRYING OUT THE INVENTION

Three flywheels each having a same size and a same weight are tandem-arranged on a horizontal surface passing through a gravity point as a center of a disc air vehicle at equal distances/equal intervals from the gravity thereof. The flywheels are rotated fast by power of a motor or an engine in a same direction and at a same speed. Furthermore, the power for rotating each of the flywheels is located at an equal interval from the gravity, and the weight is distributed such that the gravity of the disc air vehicle is located substantially at the center of the disc. There is also provided a tail rotor at a rear portion of the airframe in order to prevent rotation of the airframe in synchronization with rotation of the flywheels. Further provided is a fan for flotation and propulsion, which is arranged on the vertical axis passing through the center of the airframe at a lower location as close as possible to the gravity point. The fan for flotation and propulsion is configured to be inclined in a direction in which a control stick is pushed down, and the control stick is operated to fly the air vehicle.

### EXAMPLE

The airframe is constantly stabilized horizontally by mounting a horizontal attitude stabilization device according to the present invention to a small disc hovering aircraft for low altitude flight. Therefore, the aircraft can be easily operated even by a person with less flight experience.

### INDUSTRIAL APPLICABILITY

It is a technique not only applicable to a small leisure hovering aircraft for low altitude flight, but also useful in the development of a disc air vehicle that is provided with a horizontal attitude stabilization device according to the present invention as means for carrying human beings and goods to the outer space in the future. This technique can be expected as means that can replace the extraordinary technique on the idea of a space elevator, which is currently under development.

1. A device comprising three flywheels each having a same size and a same weight, the flywheels being tandem-arranged on a horizontal surface passing through a gravity point as a center of a disc air vehicle at equal distances/equal intervals from the gravity, wherein when the flywheels are rotated fast by power of a motor or an engine in a same direction and at a same speed, the three flywheels generate combined centrifugal force about a vertical axis passing through the gravity of the air vehicle to stabilize a horizontal attitude of an airframe.
